(19) United States
(12) Patent Application Publication
(10) Pub. No.: US 2026/0200144 A1
(43) Pub. Date: Jul. 16, 2026

(54) DISCHARGE APPARATUS, RESIN-MOLDED PRODUCT MANUFACTURING APPARATUS, AND METHOD OF MANUFACTURING RESIN-MOLDED PRODUCT

(71) Applicant: TOWA CORPORATION, Kyoto-shi, Kyoto (JP)

(72) Inventor: Ippei KITA, Kyoto-shi, Kyoto (JP)

(73) Assignee: TOWA CORPORATION, Kyoto-shi, Kyoto (JP)

(21) Appl. No.: 19/132,007

(22) PCT Filed: Sep. 26, 2023
(86) PCT No.: PCT/JP2023/034880

§ 371 Date: May 22, 2025

(30) Foreign Application Priority Data
Jan. 13, 2023 (JP) 2023-003767

(51) Int. Cl. B29C 43/34; B29C 43/18

(52) U.S. Cl. CPC B29C 43/34; B29C 43/18; B29C 2043/189; B29C 2043/3433

(57) ABSTRACT

A discharge apparatus, a resin-molded product manufacturing apparatus, and a method of manufacturing a resin-molded product that allow highly accurate control of an amount of discharge of liquid resin are provided. A discharge apparatus includes a plunger configured to be movable in a first direction and a second direction in a cartridge. The plunger is provided with a flow path that allows flow of gas between a first side where liquid resin is located and a second side opposite thereto. A check valve that allows flow of gas from the first side toward the second side when the plunger moves in the first direction and allows prevention of flow of gas from the second side toward the first side when the plunger moves in the second direction is provided.

### TECHNICAL FIELD

The present disclosure relates to a discharge apparatus, a resin-molded product manufacturing apparatus, and a method of manufacturing a resin-molded product.

### BACKGROUND ART

For example, PTL 1 describes a resin supply apparatus capable of resin molding a workpiece by pressing liquid resin stored in a syringe with a plunger to discharge the liquid resin from a nozzle to the workpiece. In the resin supply apparatus described in PTL 1, a pinch valve closes with stop of downward movement of the plunger to thereby stop discharge of the liquid resin from the nozzle.

### CITATION LIST

### Patent Literature

PTL 1: Japanese Patent Laying-Open No. 2018-134846

### SUMMARY OF INVENTION

### Technical Problem

In the resin supply apparatus described in PTL 1, however, liquid drip of liquid resin occurs at a tip end of the nozzle when downward movement of the plunger stops, and with closing of the pinch valve, liquid resin dripping at the tip end of the nozzle drops on the workpiece. Since an amount of liquid resin that drops on the workpiece is unstable, disadvantageously, an amount of discharge of liquid resin cannot highly accurately be controlled.

### Solution to Problem

According to the present disclosure, a discharge apparatus can be provided, the discharge apparatus including a cartridge holding portion configured to be capable of holding a cartridge in which liquid resin is accommodated, the cartridge being provided with an outlet from which the liquid resin is discharged, a plunger configured to be movable in a first direction and a second direction in the cartridge, and a sealing member provided to achieve hermeticity between the plunger and the cartridge, the discharge apparatus being configured to be capable of discharging the liquid resin from the outlet of the cartridge as a result of movement of the plunger in the first direction, the plunger being provided with a flow path that allows flow of gas between a first side and a second side, the first side being a side where the liquid resin is located, the second side being opposite to the first side, the plunger being provided with a check valve that allows flow of gas from the first side toward the second side when the plunger moves in the first direction and allows prevention of flow of gas from the second side toward the first side when the plunger moves in the second direction.

According to the present disclosure, a resin-molded product manufacturing apparatus can be provided, the resin-molded product manufacturing apparatus including a discharge module including the discharge apparatus described above, a press module including an upper mold and a lower mold, a first conveyance mechanism configured to be capable of conveying a substrate to the upper mold, and a second conveyance mechanism configured to be capable of conveying to the lower mold, a film to which the liquid resin has been discharged in the discharge module, the press module being configured to be capable of manufacturing a resin-molded product including the substrate by clamping by using the upper mold and the lower mold.

According to the present disclosure, a method of manufacturing a resin-molded product with the resin-molded product manufacturing apparatus described above can be provided, the method including discharging, by the discharge apparatus, the liquid resin to the film, setting the substrate in the upper mold, setting in the lower mold, the film on which the liquid resin is carried, and clamping by using the upper mold and the lower mold.

### Advantageous Effects of Invention

According to an embodiment of the present disclosure, a discharge apparatus, a resin-molded product manufacturing apparatus, and a method of manufacturing a resin-molded product that allow highly accurate control of an amount of discharge of liquid resin can be provided.

### BRIEF DESCRIPTION OF DRAWINGS

FIG. 1 is a diagram showing a schematic configuration of an exemplary resin-molded product manufacturing apparatus in an embodiment.

FIG. 2 is a partial schematic cross-sectional view of an exemplary discharge apparatus provided in a discharge module shown in FIG. 1.

FIG. 3 is a schematic enlarged partial cross-sectional view illustrating an exemplary function of a check valve when a pressing portion of a plunger moves downward.

FIG. 4 is a schematic enlarged partial cross-sectional view illustrating an exemplary function of the check valve when the pressing portion of the plunger moves upward.

FIG. 5 is a schematic enlarged partial cross-sectional view of another exemplary plunger including a check valve.

FIG. 6 (a) to (c) is a schematic partial cross-sectional view illustrating an exemplary function and effect of the discharge apparatus in the embodiment.

FIG. 7 is a flowchart of an exemplary method of manufacturing a resin-molded product in the embodiment.

FIG. 8 is a schematic cross-sectional view of an exemplary resin molding apparatus.

FIG. 9 is another schematic cross-sectional view of an exemplary resin molding apparatus.

### DESCRIPTION OF EMBODIMENTS

An embodiment will be described below. In the drawings referred to in the description of the embodiment, the same or corresponding elements have the same reference characters allotted.

### <Resin-Molded Product Manufacturing Apparatus>

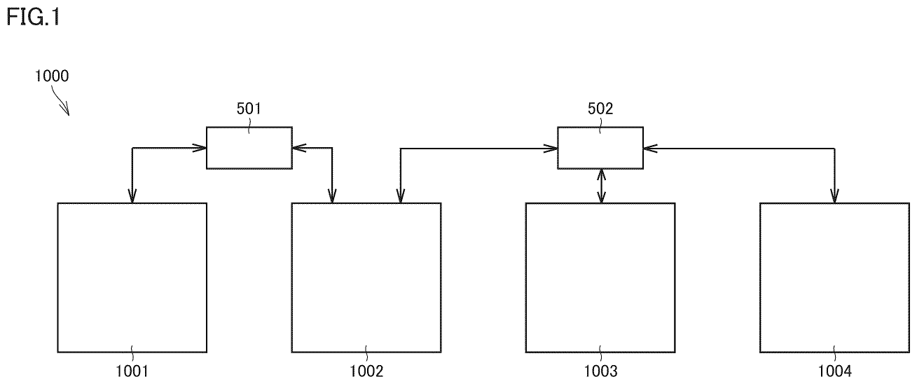

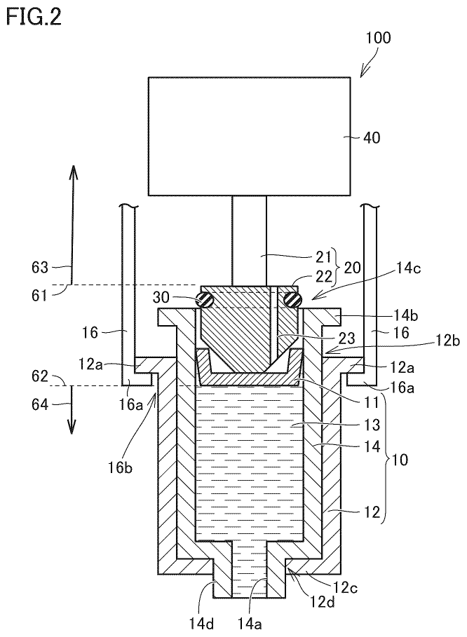

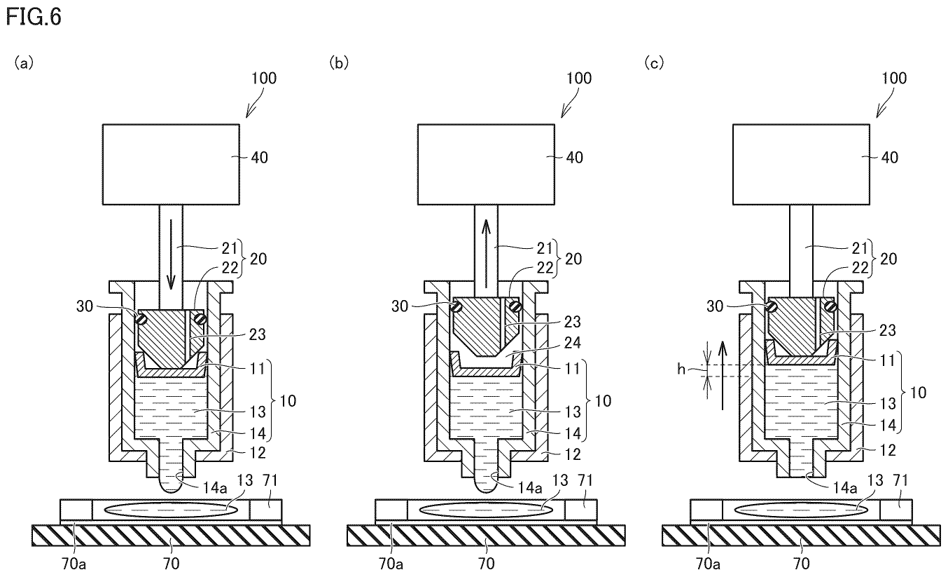

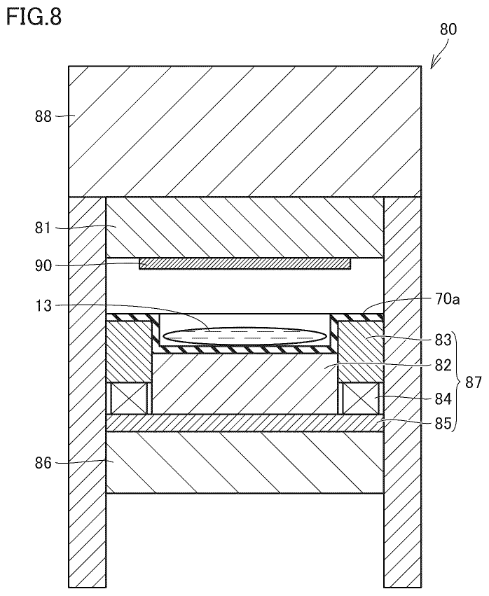

FIG. 1 shows a schematic configuration of an exemplary resin-molded product manufacturing apparatus in an embodiment. As shown in FIG. 1, a resin-molded product manufacturing apparatus 1000 includes a substrate module 1001, a press module 1002, a discharge module 1003, and a film module 1004. Substrate module 1001 is configured to be capable of carrying a substrate 90 (see FIG. 8) to be resin-molded out of the same. Film module 1004 is configured to be capable of carrying a film 70a (see FIG. 6) out of the same. Discharge module 1003 is configured to be capable of discharging thermosetting liquid resin 13 (see FIG. 2) to film 70a conveyed from film module 1004. Press module 1002 is configured to be capable of resin-molding substrate 90 conveyed from substrate module 1001 with liquid resin 13 carried on film 70a conveyed from discharge module 1003. For example, an electronic component is arranged on one surface of substrate 90, and the one surface of substrate 90 where the electronic component is arranged is sealed with resin. For example, liquid resin 13 used in a semiconductor packaging field can be employed as liquid resin 13.

Though substrate module 1001, press module 1002, discharge module 1003, and film module 1004 are described as different modules separate from one another in the example shown in FIG. 1, each module may be configured to be attachable to and removable from another module and configured to allow increase and decrease in number of modules. For example, the configuration can be such that two or three discharge modules 1003 are arranged between press module 1002 and film module 1004.

Resin-molded product manufacturing apparatus 1000 further includes a first conveyance mechanism 501 and a second conveyance mechanism 502. First conveyance mechanism 501 is configured to be capable of conveying substrate 90 carried out of substrate module 1001 to an upper mold 81 (see FIG. 8) of a molding die of a later-described resin molding apparatus 80 (see FIG. 8) of press module 1002. Second conveyance mechanism 502 is configured to be capable of conveying film 70a to which liquid resin 13 has been discharged in discharge module 1003 to a lower mold 87 (see FIG. 8) of the molding die of the later-described resin molding apparatus of press module 1002. Second conveyance mechanism 502 is further configured to be capable of conveying film 70a on which liquid resin 13 is not carried, which is carried out of film module 1004, to discharge module 1003.

### <Discharge Apparatus>

FIG. 2 shows a partial schematic cross-sectional view of an exemplary discharge apparatus provided in discharge module 1003 shown in FIG. 1. As shown in FIG. 2, a discharge apparatus 100 includes a plurality of locking portions 16 as cartridge holding portions configured to be capable of holding a cartridge 10, a plunger 20 configured to be movable upward and downward in cartridge 10, and a sealing member 30 provided to achieve hermeticity between plunger 20 and cartridge 10.

### <Cartridge Holding Portion>

The plurality of locking portions 16 as the cartridge holding portions are configured to extend in an upward-downward direction in discharge apparatus 100. Lower ends of the plurality of locking portions 16 form projecting portions 16a that project toward a side where a metallic cylinder 12 which will be described later is provided. An opening 16b for setting of later-described cartridge 10 is provided between projecting portions 16a of the plurality of locking portions 16. Each of the plurality of locking portions 16 is located on an outer side of a side surface of later-described metallic cylinder 12. The plurality of locking portions 16 are configured to be movable in the upward-downward direction and a left-right direction by a not-shown drive mechanism. The “upward-downward direction” means the upward-downward direction of the sheet plane in FIG. 2. The “left-right direction” means a direction perpendicular to the upward-downward direction of the sheet plane in FIG. 2 and in parallel to the sheet plane in FIG. 2. Projecting portions 16a of the plurality of locking portions 16 and a projecting portion 12a of metallic cylinder 12 lock together. At this time, an upper surface of projecting portion 16a of each of the plurality of locking portions 16 is in contact with a lower surface of projecting portion 12a of metallic cylinder 12. Projecting portion 16a of each of the plurality of locking portions 16 prevents downward movement of metallic cylinder 12, that is, cartridge 10. As projecting portions 16a of the plurality of locking portions 16 and projecting portion 12a of metallic cylinder 12 lock together, cartridge 10 accommodated in metallic cylinder 12 can be held. A not-shown handle may be attached to one surface on an outer side of metallic cylinder 12.

### <Plunger>

Plunger 20 is located in a space surrounded by the plurality of locking portions 16, so as not to be in contact with the plurality of locking portions 16. Plunger 20 includes a plunger pressing portion 22 and a plunger shaft portion 21 attached to plunger pressing portion 22. Plunger pressing portion 22 is configured like a column that extends in the upward-downward direction. A corner portion of a lower end surface of plunger pressing portion 22 is beveled as being tapered downward. Plunger shaft portion 21 is configured like a column that projects upward from a central portion of an upper end surface of plunger pressing portion 22. A cross-sectional area of a lateral cross-section of plunger shaft portion 21 is smaller than an area of the upper end surface of plunger pressing portion 22. The “cross-sectional area of the lateral cross-section” means a cross-sectional area of a cross-section along the left-right direction. An upper part of plunger shaft portion 21 is accommodated in a servo motor 40. Plunger pressing portion 22 attached to a lower side of plunger shaft portion 21 can be moved in the upward-downward direction by controlling an operation of servo motor 40. Plunger pressing portion 22 functions as a movable body.

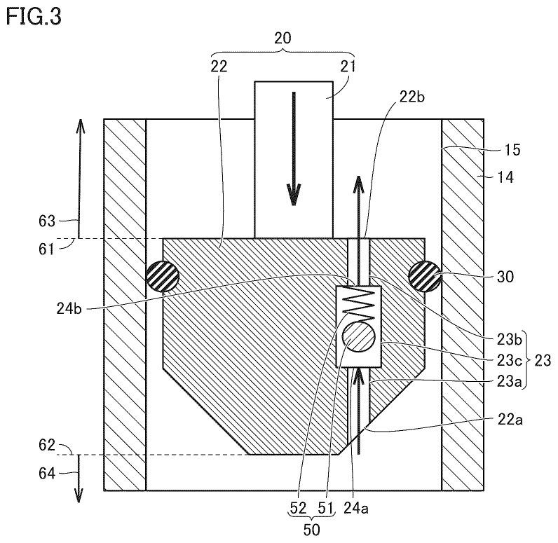

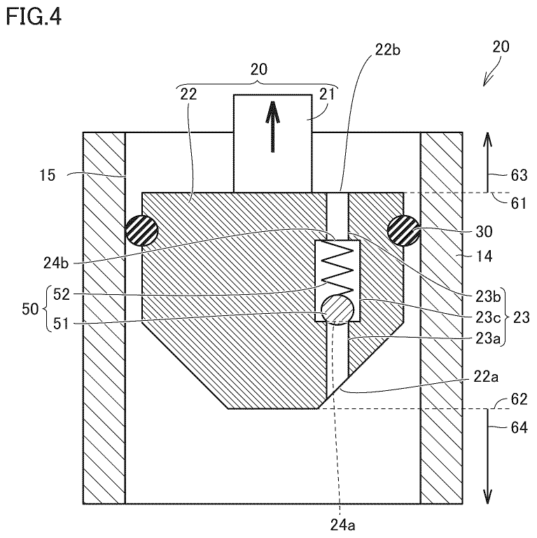

Each of the upper end surface and the lower end surface of plunger pressing portion 22 is provided with an opening. Plunger pressing portion 22 is provided with a flow path 23 that allows communication between an opening 22b (see FIGS. 3 and 4) in the upper end surface of plunger pressing portion 22 and an opening 22a (see FIGS. 3 and 4) in the lower end surface of plunger pressing portion 22. The lower side of plunger 20 is a first side which is a side where liquid resin 13 is located and a side of a first direction (a direction (downward) shown with an arrow 64) below a dashed line 62 (a virtual line in parallel to a lower surface of plunger pressing portion 22) in FIG. 2. An upper side of plunger 20 is a second side opposite to the first side and a side of a second direction (a direction (upward) shown with an arrow 63) above a dashed line 61 (a virtual line in parallel to an upper surface of plunger pressing portion 22) in FIG. 2. Flow path 23 allows flow of gas between the first side and the second side.

Plunger 20 is provided with a check valve 50 (see FIGS. 3 and 4). FIG. 2 does not show check valve 50. Check valve 50 allows flow of gas from the first side (lower side) toward the second side (upper side) of plunger 20 when plunger pressing portion 22 located in liquid resin accommodation portion 14 of cartridge 10 moves in the first direction (downward). In addition, check valve 50 allows prevention of flow of gas from the second side (upper side) toward the second side (lower side) of plunger 20 when plunger pressing portion 22 located in liquid resin accommodation portion 14 of cartridge 10 moves in the second direction (upward). Details of a function of check valve 50 will be described later.

### <Sealing Member>

An annular sealing member 30 is fitted to a side surface of plunger pressing portion 22. The side surface of plunger pressing portion 22 is provided with a recess along a circumferential direction. It is fitted in the recess in the side surface of plunger pressing portion 22. A part on an outer side of sealing member 30 is exposed through the recess in the side surface of plunger pressing portion 22. For example, an O ring or the like can be employed as sealing member 30. When plunger 20 moves in the upward-downward direction, sealing member 30 arranged at the side surface of plunger pressing portion 22 moves as coming in contact with an inner surface 15 (see FIGS. 3 and 4) of liquid resin accommodation portion 14. Therefore, hermeticity between plunger pressing portion 22 and inner surface 15 of liquid resin accommodation portion 14 of cartridge 10 can be kept also while plunger pressing portion 22 moves in the upward-downward direction.

### <Cartridge>

Discharge apparatus 100 with the configuration shown above is used, with annular projecting portion 12a projecting toward the outside of later-described metallic cylinder 12 of cartridge 10 being provided on projecting portions 16a of the plurality of locking portions 16 as the cartridge holding portions as described above. Liquid resin 13 is accommodated in cartridge 10, and cartridge 10 is provided with an outlet 14a from which liquid resin 13 is discharged. Cartridge 10 includes substantially cylindrical metallic cylinder 12 that defines the side surface of cartridge 10 extending in the upward-downward direction and substantially cylindrical liquid resin accommodation portion 14 made of plastic and provided as being fitted to the inside of metallic cylinder 12. Substantially cylindrical metallic cylinder 12 includes annular projecting portion 12a that projects from an upper end portion of the side surface of metallic cylinder 12 toward the outside of metallic cylinder 12. Annular projecting portion 12a on the upper side of metallic cylinder 12 surrounds opening 12b on the upper side of metallic cylinder 12. Metallic cylinder 12 includes an annular projecting portion 12c that projects from a lower end portion of the side surface of metallic cylinder 12 toward the inside of metallic cylinder 12. Annular projecting portion 12c on the lower side of metallic cylinder 12 surrounds an opening 12d on the lower side of metallic cylinder 12.

Liquid resin accommodation portion 14 is configured such that liquid resin 13 can be accommodated therein. Liquid resin accommodation portion 14 is, for example, a syringe. Substantially cylindrical liquid resin accommodation portion 14 is provided with a side surface that extends in the upward-downward direction. A part on an upper side of liquid resin accommodation portion 14 extends upward off upper opening 12b of metallic cylinder 12. Liquid resin accommodation portion 14 includes an annular projecting portion 14b that projects from an upper end portion of the side surface of liquid resin accommodation portion 14 toward the outside of liquid resin accommodation portion 14. An opening 14c is provided in an upper end portion of the side surface of liquid resin accommodation portion 14, on the inside of liquid resin accommodation portion 14. A lower end portion 14d of liquid resin accommodation portion 14 is configured to extend toward the inside of liquid resin accommodation portion 14 along lower projecting portion 12c of metallic cylinder 12 and then project downward from lower opening 12d of metallic cylinder 12. A portion that projects downward from lower opening 12d of metallic cylinder 12, of lower end portion 14d of liquid resin accommodation portion 14 corresponds to outlet 14a of cartridge 10.

Cartridge 10 includes a lid body 11 arranged on a surface of liquid resin 13. Lid body 11 is configured to seal liquid resin 13 so as not to leak from liquid resin accommodation portion 14. Plunger pressing portion 22 of plunger 20 described above is set at an upper surface of lid body 11 and plunger pressing portion 22 moves downward. Plunger pressing portion 22 thus presses liquid resin 13 with lid body 11 being interposed and liquid resin 13 is discharged downward from outlet 14a of cartridge 10. Old cartridge 10 can be replaced with new cartridge 10 as below. Initially, projecting portion 12a of metallic cylinder 12 of old cartridge 10 is removed from projecting portions 16a of the plurality of locking portions 16. Projecting portion 12a of metallic cylinder 12 of new cartridge 10 and projecting portions 16a of the plurality of locking portions 16 then lock together.

### <Flow Path>

FIG. 3 shows a schematic enlarged partial cross-sectional view illustrating an exemplary function of check valve 50 when plunger pressing portion 22 moves downward. FIG. 4 shows a schematic enlarged partial cross-sectional view illustrating an exemplary function of check valve 50 when plunger pressing portion 22 moves upward. As shown in FIGS. 3 and 4, flow path 23 provided in plunger pressing portion 22 of plunger 20 extends in the upward-downward direction inside plunger pressing portion 22. Flow path 23 includes a first flow path 23a, a second flow path 23b, and a third flow path 23c that extend in the upward-downward direction inside plunger pressing portion 22. A lower side of first flow path 23a communicates with opening 22a provided in the lower end surface of plunger pressing portion 22. An upper side of second flow path 23b communicates with opening 22b provided in the upper end surface of plunger pressing portion 22. An upper side of first flow path 23a communicates with a lower side of third flow path 23c. A lower side of second flow path 23b communicates with an upper side of third flow path 23c. A cross-sectional area of a lateral cross-section of first flow path 23a is smaller than a cross-sectional area of a lateral cross-section of third flow path 23c. A cross-sectional area of a lateral cross-section of second flow path 23b is smaller than the cross-sectional area of the lateral cross-section of third flow path 23c. In the example shown in FIGS. 3 and 4, check valve 50 is provided in third flow path 23c.

### <Check Valve>

In the example shown in FIGS. 3 and 4, check valve 50 includes a closing member 51 and an elastic body 52. Closing member 51 moves in the upward-downward direction in third flow path 23c. Closing member 51 is configured to be capable of closing an opening 24a that communicates with first flow path 23a, in third flow path 23c. Elastic body 52 is arranged in third flow path 23c and configured to be capable of extending and contracting in the upward-downward direction. Elastic body 52 has a lower end portion coupled to an upper end portion of closing member 51. Elastic body 52 has an upper side coupled to a surface on a side of an opening 24b that communicates with second flow path 23b, in third flow path 23c.

When plunger pressing portion 22 moves downward as shown in FIG. 3, in liquid resin accommodation portion 14, gas between plunger pressing portion 22 and lid body 11 pushes closing member 51 upward. Elastic body 52 thus contracts and closing member 51 moves upward away from opening 24a. Consequently, in third flow path 23c, a passage of gas from opening 24a to opening 24b is formed and gas on the first side (lower side: a direction (downward) shown with arrow 64 below dashed line 62) of plunger 20 passes through flow path 23 and flows out to the second side (upper side: a direction (upward) shown with arrow 63 above dashed line 61) of plunger 20.

When plunger pressing portion 22 moves upward as shown in FIG. 4, on the other hand, in third flow path 23c, gas on the second side (upper side) of plunger 20 pushes closing member 51 downward. Elastic body 52 thus extends and closing member 51 closes opening 24a. Therefore, in liquid resin accommodation portion 14, gas on the second side (upper side) of plunger 20 is prevented from passing through flow path 23 and flowing out toward the first side (lower side) of plunger 20. Consequently, flow of gas on the second side (upper side) of plunger 20 into a space between plunger pressing portion 22 and lid body 11 on the first side (lower side) of plunger 20 is prevented.

As set forth above, when plunger pressing portion 22 moves downward (in the first direction), check valve 50 allows flow of gas from the lower side (first side) toward the upper side (second side) in plunger pressing portion 22. When plunger pressing portion 22 moves upward (in the second direction), check valve 50 can prevent flow of gas from the upper side (second side) toward the lower side (first side) in plunger pressing portion 22.

The configuration of check valve 50 is not limited to the configuration including closing member 51 and elastic body 52. Check valve 50 should only be configured such that opening 24a is closed when plunger pressing portion 22 moves upward and closing of opening 24a is canceled when plunger pressing portion 22 moves downward.

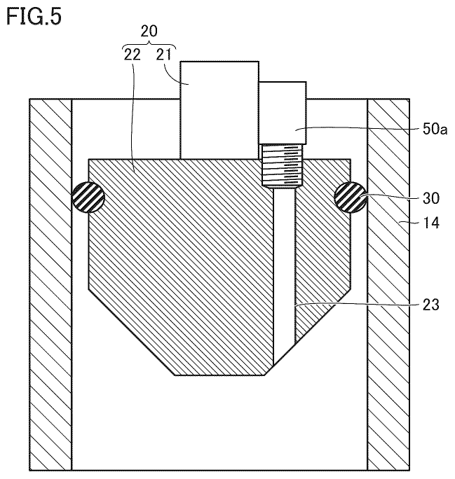

FIG. 5 shows a schematic enlarged partial cross-sectional view of another exemplary plunger including the check valve. Plunger 20 further includes a columnar attachment member 50a that extends in the upward-downward direction. As shown in FIG. 5, the upper end surface of plunger pressing portion 22 is provided with a screw hole that extends downward from the upper end surface of plunger pressing portion 22. A thread groove is provided at a lower side of attachment member 50a. By screwing the thread groove at the lower side of attachment member 50a with the screw hole in plunger pressing portion 22, attachment member 50a is attached to plunger pressing portion 22.

An upper end surface and a lower end surface of attachment member 50a are each provided with an opening (not shown). A flow path (not shown) that allows communication between the openings in the upper end surface and the lower end surface of attachment member 50a is provided inside attachment member 50a. Plunger pressing portion 22 is provided with flow path 23 that communicates with the opening provided in the lower end surface of attachment member 50a. Flow path 23 in plunger pressing portion 22 communicates with the opening provided in the lower end surface of attachment member 50a. Flow path 23 in plunger pressing portion 22 and the flow path provided inside attachment member 50a form a flow path that allows flow of gas between the first side and the second side of plunger 20.

In the example shown in FIG. 5, check valve 50 that performs the function shown in FIGS. 3 and 4 is provided inside attachment member 50a. For example, a flow path (which will be referred to as an “A flow path” below) that communicates with the opening in the lower end surface of attachment member 50a is provided inside attachment member 50a, as a flow path corresponding to first flow path 23a shown in FIGS. 3 and 4 that extends in the upward-downward direction. In addition, a flow path (which will be referred to as a “B flow path” below) that communicates with the opening in the upper end surface of attachment member 50a is provided inside attachment member 50a, as a flow path corresponding to second flow path 23b shown in FIGS. 3 and 4 that extends in the upward-downward direction. Furthermore, a C flow path that allows communication between the A flow path and the B flow path is provided inside attachment member 50a, as a flow path corresponding to third flow path 23c shown in FIGS. 3 and 4 that extends in the upward-downward direction. An upper side of the A flow path communicates with a lower side of the C flow path. A lower side of the B flow path communicates with an upper side of the C flow path. A cross-sectional area of a lateral cross-section of the A flow path is smaller than a cross-sectional area of a lateral cross-section of the C flow path. A cross-sectional area of a lateral cross-section of the B flow path is smaller than the cross-sectional area of the lateral cross-section of the C flow path. Check valve 50 of attachment member 50a is provided in the C flow path as in FIGS. 3 and 4.

The configuration may be such that a screw hole that extends downward from the lower end surface of attachment member 50a is provided. In this case, a columnar body that projects upward from the upper end surface of plunger pressing portion 22 and is provided with a thread groove at its outer surface is provided on the upper end surface of plunger pressing portion 22. As the thread groove on the upper side of the columnar body is screwed with the screw hole in the lower end surface of attachment member 50a, attachment member 50 is attached to plunger pressing portion 22. In this case again, the flow paths (the A flow path, the B flow path, and the C flow path) similar to those above are provided inside the columnar body that projects upward from the upper end surface of plunger pressing portion 22 and attachment member 50.

### <Functions and Effects of Discharge Apparatus>

FIG. 6 (a) to (c) shows a schematic partial cross-sectional view illustrating an exemplary function and effect of discharge apparatus 100 in the embodiment. FIG. 6 (a) to (c) does not show projecting portion 12a of metallic cylinder 12 and the plurality of locking portions 16. Initially, as shown in FIG. 6 (a), while plunger pressing portion 22 is located on the upper side of lid body 11 of cartridge 10, operation of servo motor 40 is controlled to move plunger pressing portion 22 downward. Plunger pressing portion 22 thus presses lid body 11 of cartridge 10 downward. Consequently, liquid resin 13 accommodated in liquid resin accommodation portion 14 is pressed and liquid resin 13 is discharged downward from outlet 14a of cartridge 10. When plunger pressing portion 22 moves downward, closing member 51 of check valve 50 opens opening 24a provided in third flow path 23c as shown in FIG. 3.

A base 70 is arranged under cartridge 10. Film 70a is placed on base 70. A tray cover 71 in a form of a frame is arranged on film 70a. Outlet 14a of cartridge 10 is located above film 70a within tray cover 71. Therefore, liquid resin 13 discharged from outlet 14a drops on film 70a within tray cover 71.

When discharge apparatus 100 completes discharge of liquid resin 13, operation of servo motor 40 is then controlled to stop downward movement of plunger pressing portion 22. At this time, liquid drip of liquid resin 13 occurs in the vicinity of outlet 14a. After downward movement of plunger pressing portion 22 is stopped, plunger pressing portion 22 is moved upward as shown in FIG. 6 (b). When plunger pressing portion 22 moves upward, closing member 51 of check valve 50 closes opening 24a provided in third flow path 23c as shown in FIG. 4. Sealing member 30 keeps hermeticity between plunger pressing portion 22 and inner surface 15 of liquid resin accommodation portion 14 of cartridge 10. Therefore, when plunger pressing portion 22 moves upward, a state of the space between plunger pressing portion 22 and lid body 11 is under vacuum or close to a vacuum. Therefore, a barometric pressure in a space 24 between plunger pressing portion 22 and lid body 11 is set to a negative pressure lower than the atmospheric pressure.

Consequently, liquid drip of liquid resin 13 is pushed upward by the atmospheric pressure. As shown in FIG. 6 (c), an upper surface of liquid resin 13 and lid body 11 thus move upward, for example, by a height h. Consequently, lid body 11 comes in contact with plunger pressing portion 22 again. By moving plunger pressing portion 22 upward as above, liquid drip of liquid resin 13 that occurs in the vicinity of outlet 14a can return to the inside of liquid resin accommodation portion 14 (this phenomenon will be referred to as “suck back” below). In the resin supply apparatus described in PTL 1, when discharge of liquid resin is completed, the pinch valve closes the flow path in the nozzle and hence liquid drip occurs at the tip end of the nozzle. Since suck back is achieved in discharge apparatus 100 in the embodiment, occurrence of drop of liquid resin 13 can be suppressed. Discharge apparatus 100 in the embodiment and the resin-molded product manufacturing apparatus including discharge apparatus 100 in the embodiment can thus control the amount of discharge of liquid resin 13 more highly accurately than the resin supply apparatus described in PTL 1.

### <Method of Manufacturing Resin-Molded Product>

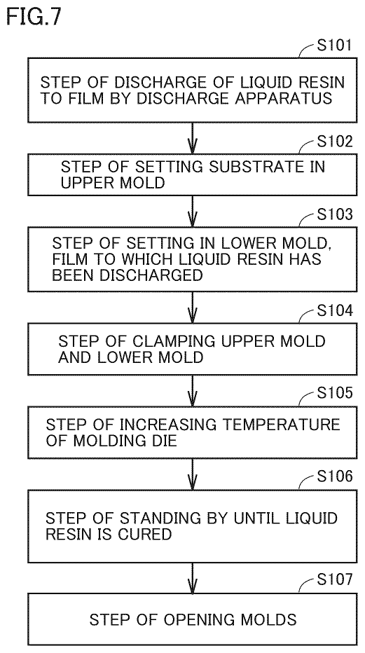

FIG. 7 shows a flowchart of an exemplary method of manufacturing a resin-molded product in the embodiment. As shown in FIG. 7, in the method of manufacturing a resin-molded product in the embodiment, initially, discharge apparatus 100 discharges liquid resin 13 to film 70a (step S101). First conveyance mechanism 501 then sets substrate 90 at a lower surface of upper mold 81 (see FIG. 8) of the molding die (step S102). At this time, an electronic component is located on a lower surface of substrate 90. Step S102 may be performed before step S101. Step S101 and step S102 may simultaneously be performed. Step S101 may be performed while step S102 is performed. The molding die includes upper mold 81 and lower mold 87.

After step S101 is performed, second conveyance mechanism 501 sets film 70a on which liquid resin 13 is carried, at an upper surface of lower mold 87 of the molding die (step S103). After step S103 is performed, lower mold 87 is moved upward toward upper mold 81 for clamping (step S104). When upward movement of lower mold 87 stops, clamping is performed and thereafter a temperature of the molding die is increased (step S105). After step S105 is performed, a stand-by step is performed until liquid resin 13 is cured (step S106). After step S106 is performed, lower mold 87 is moved downward to open the molds (step S107). A resin-molded product in which the lower surface of substrate 90 is sealed with resin is thus manufactured.

Step S101 is performed, for example, as below. Initially, second conveyance mechanism 502 conveys film 70a and tray cover 71 in the form of the frame arranged on film 70a from film module 1004 shown in FIG. 1 to discharge module 1003. Discharge apparatus 100 of discharge module 1003 then discharges liquid resin 13 from outlet 14a of cartridge 10 to film 70a within tray cover 71. Discharge of liquid resin 13 by discharge apparatus 100 is performed, for example, in a manner shown in FIG. 6 (a) to (c).

In step S102, for example, first conveyance mechanism 501 conveys substrate 90 from substrate module 1001 shown in FIG. 1 to press module 1002 and sets the substrate at the lower surface of upper mold 81 of the molding die of press module 1002.

In step S103, for example, second conveyance mechanism 502 conveys film 70a to which liquid resin 13 has been discharged together with tray cover 71 from discharge module 1003 shown in FIG. 1 to press module 1002, and sets film 70a on which liquid resin 13 is carried, at the upper surface of lower mold 87 of the molding die of press module 1002. Second conveyance mechanism 502 conveys tray cover 71 to film module 1004, without setting tray cover 71 in press module 1002.

FIG. 8 shows a schematic cross-sectional view of an exemplary resin molding apparatus after step S101 to step S103 end. In resin molding apparatus 80 shown in FIG. 8, a fixed platen 88 in a form of a block is supported by a tie bar or a hold frame. Upper mold 81 is set on a lower side of fixed platen 88. A movable platen 86 in a form of a plate that moves in the upward-downward direction along the tie bar or the hold frame is arranged on the lower side of fixed platen 88. Lower mold 87 is set on an upper side of movable platen 86.

Lower mold 87 includes a bottom surface member 82 in a form of a parallelepiped, a side surface member 83 in a form of a frame, a plurality of elastic members 84, and a base plate 85. Base plate 85 is provided on the upper side of movable platen 86. Bottom surface member 82 is provided on an upper side of base plate 85. Bottom surface member 82 has a side surface covered with side surface member 83. The plurality of elastic members 84 are arranged between a lower surface of side surface member 83 and base plate 85. The plurality of elastic members 84 extend and contract in the upward-downward direction. An upper surface of side surface member 83 is located above the upper surface of bottom surface member 82 and lower mold 87 is provided with a recess which is recessed downward. Second conveyance mechanism 502 sets film 70a at the upper surface of lower mold 87 such that liquid resin 13 on film 70a is located at a bottom surface of the recess. First conveyance mechanism 501 sets substrate 90 at the lower surface of upper mold 81 as shown in FIG. 8.

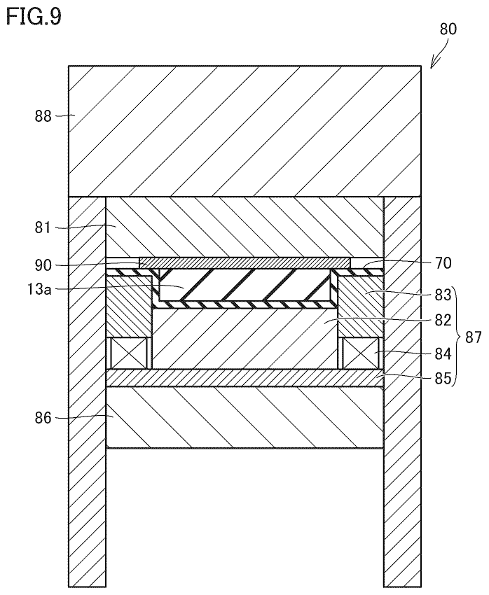

FIG. 9 shows a schematic cross-sectional view of an exemplary resin molding apparatus after step S104 ends. In step S104, a not-shown clamping mechanism moves movable platen 86 shown in FIG. 8 upward. Lower mold 87 thus moves upward toward upper mold 81. As movable platen 86 moves upward, initially, side surface member 83 in the form of the frame abuts on substrate 90 with film 70a being interposed. Thereafter, upward movement of movable platen 86 continues. Consequently, while upward movement of side surface member 83 remains stopped, side surface member 82 moves upward and the plurality of elastic members 84 contract. When a position of the upper surface of side surface member 83 reaches a predetermined position, upward movement of movable platen 86 stops and clamping in step S104 ends. After step S104 ends, in step S105, the temperature of the molding die is increased. Liquid resin 13 is thermosetting. Therefore, when the temperature of liquid resin 13 increases, liquid resin 13 is cured to become cured resin 13a. Step S106 of standing by is performed until liquid resin 13 is cured. After step S106 is performed, in step S107, base plate 85 is moved downward to move lower mold 87 downward. The molds are thus opened and the resin-molded product in which the lower surface of substrate 90 is sealed with resin is manufactured.

In the method of manufacturing the resin-molded product in the embodiment, discharge apparatus 100 in the embodiment described above discharges liquid resin 13. Therefore, the resin-molded product for which the amount of discharge of liquid resin 13 is controlled more highly accurately than in the resin supply apparatus described in PTL 1 can be manufactured.

### <Additional Aspects>

### (Disclosure 1)

Disclosure 1 is directed to a discharge apparatus including a cartridge holding portion configured to be capable of holding a cartridge in which liquid resin is accommodated, the cartridge being provided with an outlet from which the liquid resin is discharged, a plunger configured to be movable in a first direction and a second direction in the cartridge, and a sealing member provided to achieve hermeticity between the plunger and the cartridge, the discharge apparatus being configured to be capable of discharging the liquid resin from the outlet of the cartridge as a result of movement of the plunger in the first direction, the plunger being provided with a flow path that allows flow of gas between a first side and a second side, the first side being a side where the liquid resin is located, the second side being opposite to the first side, the plunger being provided with a check valve that allows flow of gas from the first side toward the second side when the plunger moves in the first direction and allows prevention of flow of gas from the second side toward the first side when the plunger moves in the second direction.

### (Disclosure 2)

Disclosure 2 is directed to the discharge apparatus described in Disclosure 1, in which the cartridge includes a lid body arranged on a surface of the liquid resin and the plunger is configured to be capable of pressing the liquid resin with the lid body being interposed.

### (Disclosure 3)

Disclosure 3 is directed to the discharge apparatus described in Disclosure 1 or 2, in which the cartridge includes a liquid resin accommodation portion configured such that liquid resin can be accommodated therein.

### (Disclosure 4)

Disclosure 4 is directed to the discharge apparatus described in any one of Disclosures 1 to 3, in which the plunger includes a movable body configured to be movable in the first direction and the second direction and the check valve is attached to the second side of the movable body.

### (Disclosure 5)

Disclosure 5 is directed to the discharge apparatus described in Disclosure 4, in which the check valve is attached to the movable body by screwing.

### (Disclosure 6)

Disclosure 6 is directed to the discharge apparatus described in any one of Disclosures 1 to 3, in which the flow path includes a first flow path that communicates with an opening of the plunger on the first side, a second flow path that communicates with an opening of the plunger on the second side, and a third flow path between the first flow path and the second flow path, and the check valve is provided in the third flow path.

### (Disclosure 7)

Disclosure 7 is directed to the discharge apparatus described in Disclosure 6, in which the check valve includes a closing member configured to be capable of closing an opening of the third flow path on a side of the first flow path when the plunger moves in the second direction and to open the opening when the plunger moves in the first direction.

### (Disclosure 8)

Disclosure 8 is directed to a resin-molded product manufacturing apparatus including a discharge module including the discharge apparatus described in any one of Disclosures 1 to 7, a press module including an upper mold and a lower mold, a first conveyance mechanism configured to be capable of conveying a substrate to the upper mold, and a second conveyance mechanism configured to be capable of conveying to the lower mold, a film to which the liquid resin has been discharged in the discharge module, the press module being configured to be capable of manufacturing a resin-molded product including the substrate by clamping by using the upper mold and the lower mold.

### (Disclosure 9)

Disclosure 9 is directed to a method of manufacturing a resin-molded product with the resin-molded product manufacturing apparatus described in Disclosure 8, the method including discharging, by the discharge apparatus, the liquid resin to the film, setting the substrate in the upper mold, setting in the lower mold, the film on which the liquid resin is carried, and clamping by using the upper mold and the lower mold.

Though the embodiment has been described as above, combination of features in each embodiment and each example described above as appropriate is also originally intended.

It should be understood that the embodiment disclosed herein is illustrative and non-restrictive in every respect. The scope of the present invention is defined by the terms of the claims rather than the description above and is intended to include any modifications within the scope and meaning equivalent to the terms of the claims.

### REFERENCE SIGNS LIST

10 cartridge; 11 lid body; 12 metallic cylinder; 12a, 12c, 14b, 16a projecting portion; 12b, 12d, 14c, 22a, 22b, 24a, 24b opening; 13 liquid resin; 13a cured resin; 14 liquid resin accommodation portion; 14a outlet; 14d lower end portion; 15 inner surface; 16 a plurality of locking portions; 20 plunger; 21 plunger shaft portion; 22 plunger pressing portion; 23 flow path; 23a first flow path; 23b second flow path; 23c third flow path; 30 sealing member; 40 servo motor; 50 check valve; 50a attachment member 50a; 51 closing member; 52 elastic body; 61, 62 dashed line; 63, 64 arrow; 70 base; 70a film; 71 tray cover; 80 resin molding apparatus; 81 upper mold; 82 bottom surface member; 83 side surface member; 84 elastic member; 85 base plate; 86 movable platen; 87 lower mold; 88 fixed platen; 90 substrate; 100 discharge apparatus; 501 first conveyance mechanism; 502 second conveyance mechanism; 1000 resin-molded product manufacturing apparatus; 1001 substrate module; 1002 press module; 1003 discharge module; 1004 film module.

1. A discharge apparatus comprising:
a cartridge holding portion configured to be capable of holding a cartridge in which liquid resin is accommodated, the cartridge being provided with an outlet from which the liquid resin is discharged;
a plunger configured to be movable in a first direction and a second direction in the cartridge; and
a sealing member provided to achieve hermeticity between the plunger and the cartridge, wherein
the discharge apparatus is configured to be capable of discharging the liquid resin from the outlet of the cartridge as a result of movement of the plunger in the first direction,
the plunger is provided with a flow path that allows flow of gas between a first side and a second side, the first side being a side where the liquid resin is located, the second side being opposite to the first side, and
the plunger is provided with a check valve that allows flow of gas from the first side toward the second side when the plunger moves in the first direction and allows prevention of flow of gas from the second side toward the first side when the plunger moves in the second direction.

2. The discharge apparatus according to claim 1, wherein
the cartridge includes a lid body arranged on a surface of the liquid resin, and
the plunger is configured to be capable of pressing the liquid resin with the lid body being interposed.

3. The discharge apparatus according to claim 1, wherein
the plunger includes a movable body configured to be movable in the first direction and the second direction, and
the check valve is attached to the second side of the movable body.

4. The discharge apparatus according to claim 3, wherein
the check valve is attached to the movable body by screwing.

5. The discharge apparatus according to claim 1, wherein
the flow path includes
a first flow path that communicates with an opening of the plunger on the first side,
a second flow path that communicates with an opening of the plunger on the second side, and
a third flow path between the first flow path and the second flow path, and the check valve is provided in the third flow path.

6. The discharge apparatus according to claim 5, wherein
the check valve includes a closing member configured to be capable of closing an opening of the third flow path on a side of the first flow path when the plunger moves in the second direction and to cancel closing of the opening when the plunger moves in the first direction.

7. A resin-molded product manufacturing apparatus comprising:
a discharge module including the discharge apparatus according to claim 1;
a press module including an upper mold and a lower mold;
a first conveyance mechanism configured to be capable of conveying a substrate to the upper mold; and
a second conveyance mechanism configured to be capable of conveying to the lower mold, a film to which the liquid resin has been discharged in the discharge module, wherein
the press module is configured to be capable of manufacturing a resin-molded product including the substrate by clamping by using the upper mold and the lower mold.

8. A method of manufacturing a resin-molded product with the resin-molded product manufacturing apparatus according to claim 7, the method comprising:
discharging, by the discharge apparatus, the liquid resin to the film;
setting the substrate in the upper mold;
setting in the lower mold, the film on which the liquid resin is carried; and
clamping by using the upper mold and the lower mold.
